(19) United States
(12) Patent Application Publication
(10) Pub. No.: US 2009/0125318 A1
(43) Pub. Date: May 14, 2009

(54) SYSTEM AND METHOD OF PROVIDING MARKETING PRODUCTION

(75) Inventors: Darlene K. Eilenberger, Shelby Township, MI (US); Michael D. Bisig, Milford, MI (US); Stephen G. Bristow, Waterford, MI (US)

Correspondence Address: HOWARD & HOWARD ATTORNEYS PLLC;BASF CORPORATION, 450 West Fourth Street, Royal Oak, MI, 48067, US

(73) Assignee: BASF CORPORATION, SOUTHFIELD, MI (US)

(21) Appl. No.: 11/938,930

(22) Filed: Nov. 13, 2007

(51) Int. Cl. G06Q 10/00

(52) U.S. Cl. 705/1

(57) ABSTRACT

A method of providing marketing products to a user includes storing the marketing products in a data storage device. The marketing products are categorized such that each marketing product is associated with at least one category. A graphic is divided into a plurality of categories and displayed to the user via a display. Each category is selectable by the user using an input device. In response to a category being selected by the user, a list of marketing products is presented to the user via the display. The list corresponds to the category selected by the user. A selection from the user of one of the marketing products presented on the list is received via the input device. In response to the selection of the marketing product, the marketing product is sent to the user.

### BACKGROUND OF THE INVENTION

1. Field of the Invention

The invention generally relates to a computer-implemented method of providing marketing products to a user. Specifically, the invention relates to a method of providing marketing products related to vehicle refinishing.

2. Description of the Related Art

Salespersons for various organizations typically utilize a number of marketing products in the course of their operations. For example, a salesperson may utilize a document, such as a product brochure, to convey important information about the offerings of the organization to a client or perspective client. In another example, a salesperson may use a computer program to research and analyze important information about a client or perspective client.

One difficulty facing these salespersons is the usually scattered and disorganized filing and storage of these marketing products. Even when the marketing products are in a completely digital format, access to the marketing products is scattered among different websites and/or directories on hard disk drive of the salesperson's computer. With this disorganization follows the difficulty in selecting the correct marketing products for a client or prospective client. For example, in the business of vehicle refinishing, i.e., car painting, a marketing product tailored for an independently owned collision center may not be appropriate for an executive in a large national chain of collision center franchises, and vice-versa.

Therefore, there remains an opportunity to provide a method and system for providing marketing products to a salesperson in a more efficient manner as well as to provide the correct marketing products based on the type of client or prospective client.

### SUMMARY OF THE INVENTION AND ADVANTAGES

The subject invention provides a computer-implemented method of providing marketing products to a user. The method includes the step of storing the marketing products in a data storage device. The marketing products are categorized such that each marketing product is associated with at least one category. The method also includes the step of displaying a graphic viewable by the user via a display. The graphic is divided into a plurality of categories with each category selectable by the user. The method further includes the step of receiving a selection from the user of one of the categories displayed on the graphic via an input device. In response to receiving the selection from the user, a list of marketing products is presented to the user via the display. The list corresponds to the category selected by the user. The method also includes the step of receiving a selection from the user via the input device of one of the marketing products presented on the list. In response to the selection of the marketing product, the method also includes sending the marketing product selected by the user from the list.

The marketing products may be related to vehicle refinishing. Furthermore, the method may include the step of grouping a plurality of categories together based on a common characteristic to form a plurality of category groups. Moreover, the graphic may be arranged according to the category groups.

The method of the subject invention provides numerous advantages over that of the prior art. For instance, the method provides a single, unified interface for the user, e.g., a salesperson, to access marketing products. This saves the user significant time in locating desired marketing products from various sources and locations. Also, the method provides a categorization of the marketing products. This categorization ensures that only the most proper and suitable marketing products are accessed by the user for each particular category.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a conceptual view of a system of the subject invention including a data storage device in communication with a terminal via a network;

FIG. 2 is a block diagram showing a method of the subject invention;

FIG. 3 is a representation of a graphic displayed on a display showing various categories and groupings of categories; and

FIG. 4 is a representation of the graphic showing marketing products presented on a list.

### DETAILED DESCRIPTION OF THE INVENTION

Referring to the Figures, wherein like numerals indicate corresponding parts throughout the several views, a system 10 and method 100 of providing marketing products to a user is shown. The marketing products described herein are related to marketing vehicle refinishing products such as vehicle paint, the components of vehicle paint, installation equipment, and related accessories. The end consumer, i.e., customer of these vehicle refinishing products are generally referred to as collision centers, “bump shops”, etc., that typically specialize in repairing and repainting vehicles after a collision. However, those skilled in the art realize that the teachings of the system 10 and method 100 may be applied to other industries as well.

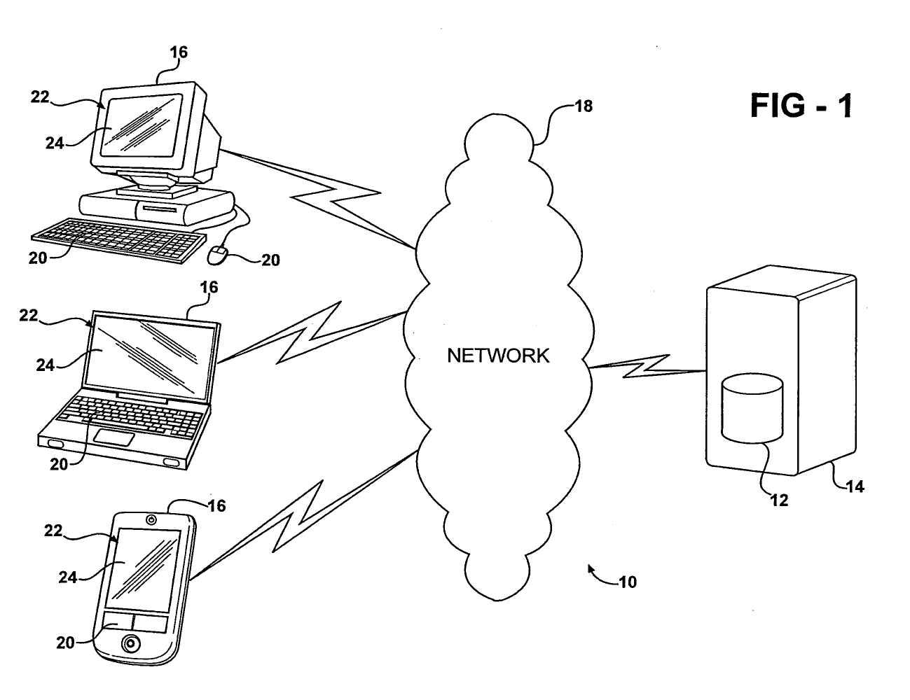

Referring to FIG. 1, the system 10 includes a data storage device 12 capable of storing data, i.e., computerized data, typically in digital or binary form. In the illustrated embodiment, the data storage device 12 is a hard disk drive 14 as is commonly known to those skilled in the art. However, other data storage devices 12, such as electronic memory devices (RAM, ROM, flash memory, etc.), may be alternatively utilized.

The data storage device 12 is in communication with a computer file server 14. Preferably, the data storage device 12 is integrated with the file server 14. However, the data storage device 12 and the file server 14 may be disposed apart from one another as is readily known by those skilled in the art. The file server 14 is preferably a microprocessor based computer with an operating system and executing a file serving program. Such file servers 14 are commercially available from Dell, Inc., of Round Rock, Tex. and Hewlett-Packard Co., of Palo Alto, Calif., as well as other manufacturers.

At least one terminal 16 is in communication with the data storage device 12. Specifically, in the illustrated embodiment, the terminal 16 is in communication with the file server 14, which integrates the data storage device 12. The terminal 16 may be one of many computing devices, including, but not limited to a desk top personal computer (PC), a laptop/notebook PC, a personal digital assistant (PDA), and a cellular/mobile telephone (or “smart phone”). As such, the terminal 16 includes a microprocessor (not shown) for running programs and controlling operating of the terminal 16. Other implementations of the terminal 16 are easily contemplated by those skilled in the art.

In the illustrated embodiment, a network 18 facilitates communication between the terminal 16 and the file server 14. The network 16 is preferably the global telecommunications network known as the Internet. However, other networking techniques may be alternatively implemented, such as a local area network (LAN), often referred to as an “intranet”, as is well known to those skilled in the art. The network may be accessed by either hard-wired or wireless techniques, as is also well known to those skilled in the art.

The terminal 16 is usable by the user of the system 10. Specifically, the terminal 16 includes at least one input device 20 and at least one output device 22. The output device 22 provides information output from the terminal 16. The output device 22 preferably includes a display 24 for visually displaying the information (or data) to the user. However, other output devices 22, such as audio speakers, may also or alternatively be utilized. The input device 20 accepts input of data or commands to the terminal 16. Those skilled in the art realize numerous implementations of the input device 20, including, but not limited to, a keyboard, pushbuttons, a pointing device (e.g., a mouse or trackball) and a touch screen interface.

The system 10 of the illustrated embodiment implements a “client-server” arrangement between the file server 14 (the “server”) and the terminal 16 (the “client”). Specifically, in this arrangement, the file server 14 sends an executable program to the terminal 16 that is executed, i.e., run, on the terminal 16. Preferably, the executable program is a Java-based program and the terminal 16 is capable of running the Java program. As those skilled in the art realize, this arrangement allows operation of the executable program over a wide variety of operating system platforms, such as, but not limited to, Microsoft Windows, Apple MacOS, Unix, or Linux. Most preferably, the Java program is run as an “applet” within an Internet browser, such as Mozilla Firefox or Microsoft Internet Explorer. Of course, the executable program could be written in other multi-platform programming languages, such as Microsoft ActiveX or Abode Flash, or a platform specific programming language.

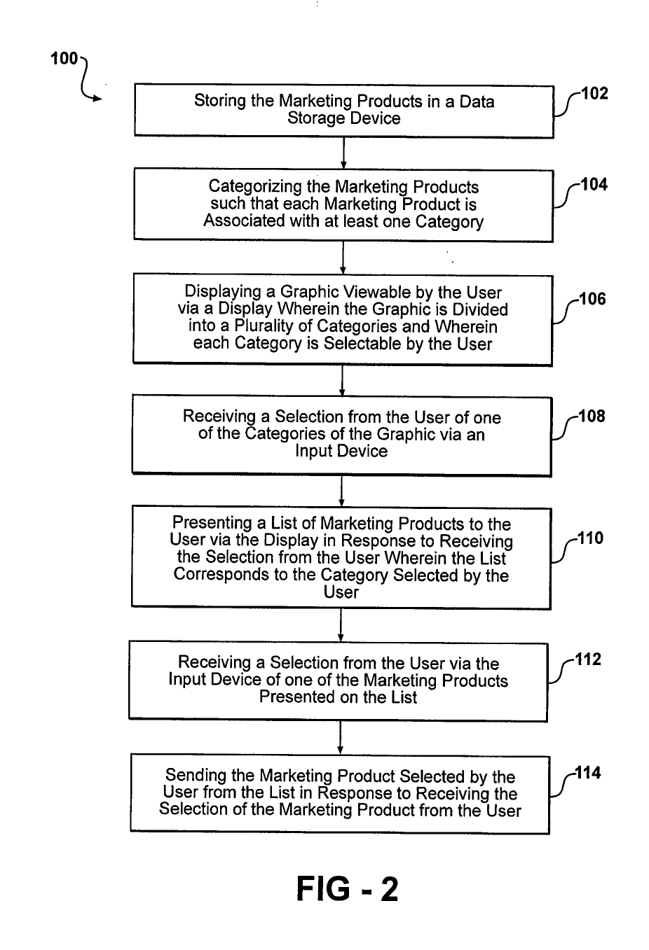

With reference to FIG. 2, the method 100 is described hereafter with respect to the aforementioned system 10. However, the method 100 may be implemented with other systems and other techniques.

The method 100 includes the step 102 of storing the marketing products in the data storage device 12. Accordingly, each marketing product is arranged into computerized data files that are storable on the data storage device 12. In a first form, the marketing product may be readable documents, such as Adobe Acrobat PDF files or Microsoft PowerPoint presentations. Other types of readable documents are known to those skilled in the art. In a second form, the marketing product may be a computer program that is executable on the file server 14 and/or the terminal 16. For example, the computer program may be an interactive application that provides the location of various collision centers in a geographic area in response to an input from the user, such as a ZIP Code or Area Code. In a third form, the marketing product may be statistical data stored in a database or a computerized spreadsheet. For example, the statistical data may include sales data for a collision center, a particular product type, etc. Those skilled in the art realize other forms of marketing products that may be arranged into computerized data files and stored on the data storage device 12.

The method 100 also includes the step 104 of categorizing the marketing products such that each marketing product is associated with at least one category 26. The categories 26 are divided based on the specific industry in which the system 10 and method 100 are to be utilized. Of course, each marketing product may be associated with more than one category 26.

The method of the illustrated embodiment also includes the step of grouping the categories 26 together based on a common characteristic to form a plurality of category groups 28. In the illustrated embodiment, where the industry is vehicle refinishing, the category groups 28 include:
the manufacturer of paint and accessories for vehicle refinishing;
customers, i.e., end users, of the paint and accessories for vehicle refinishing (e.g., collision centers, bump shops, etc.);
distributors of the paint and accessories for vehicle refinishing;
products, i.e., the different types of paints and accessories for vehicle refinishing;
business tools related to paint and accessories for vehicle refinishing including educational materials;
insurance concerns; and
environmental concerns.

Furthermore, the category groups 28 may also be broken down into subcategory groups (not individually numbered). For example, a customer category group known as a Multi-Store Operations (MSO) category group, may be segmented into several subcategory groups based on the number of stores operated by a single business group.

There are numerous techniques for categorizing and grouping marketing products other than the categories 26 and groups 28 that are depicted in the illustrated embodiment. The particular categories 26 and groups 28 shown in the illustrated embodiment, while believed to be extremely useful, especially in the vehicle refinish industry, should therefore not be construed as the only possible embodiment of categories 26 and groups 28. Furthermore, some categories 26 may not be associated with one of the category groups 28.

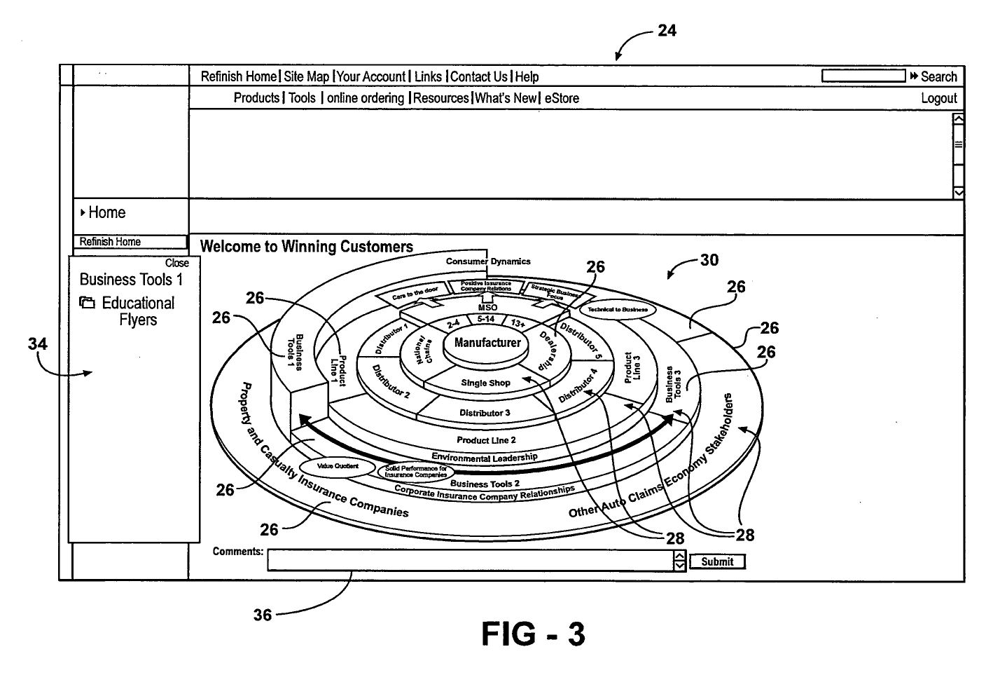

The method 100 further includes the step 106 of displaying a graphic 30 viewable by the user via the display 24. The graphic 30, shown in FIG. 3, is divided into the categories 26. Furthermore, the graphic 30 is visually divided into the groups 28 of categories 26. In the illustrated embodiment, each category group 28 is symbolized in the graphic 30 as a geometric shape (not individually numbered). Specifically, in the illustrated embodiment, each of the geometric shapes is circular. However, the geometric shape which symbolizes each category group 28 could alternatively be rectangular, triangular, etc., based on the categories 26 and the category groups 28. Furthermore, each geometric shape arranged around a common axis (not numbered). The graphic 30 of the illustrated embodiment appears as six concentric disks stacked one upon the other. The diameter of each disk is different with the smallest diameter disk on top and the largest diameter disk on bottom, created a stepped effect. The category 26 representing the manufacturer of the vehicle refinishing paint and accessories is represented by the smallest (top) disk, such that all of the other categories 26 spread downwards and outwards from the manufacturer category 26.

Since some of the categories 26 may not be associated with one of the groups 28, the representation of these categories 26 on the graphic 30 may not be included in the concentric disks described above. However, the graphic representations of these categories 26 may be integrated with the graphic 30 in other fashions without disturbing the overall effect of the concentric disks.

Each category 26 and/or group 28 may be represented in the graphic 26 by a different color. Said another way, the categories 26 and/or groups 28 may be “color-coded”. The color selection may be determined by any of a number of factors, including, but not limited to, aesthetics or branding.

By arranging the category groups 28 in geometric shapes, the user, typically a salesperson, is able to quickly recognize and discern the category 26 that corresponds to the audience which the user is targeting. The use of the visual presentation of the graphic 30 as illustrated, including the color-coding of the categories 26 and/or groups 28, allows for easier cognitive recognition of the categories 26 and groups 28, when compared to a mere listing of categories 26 and groups 28.

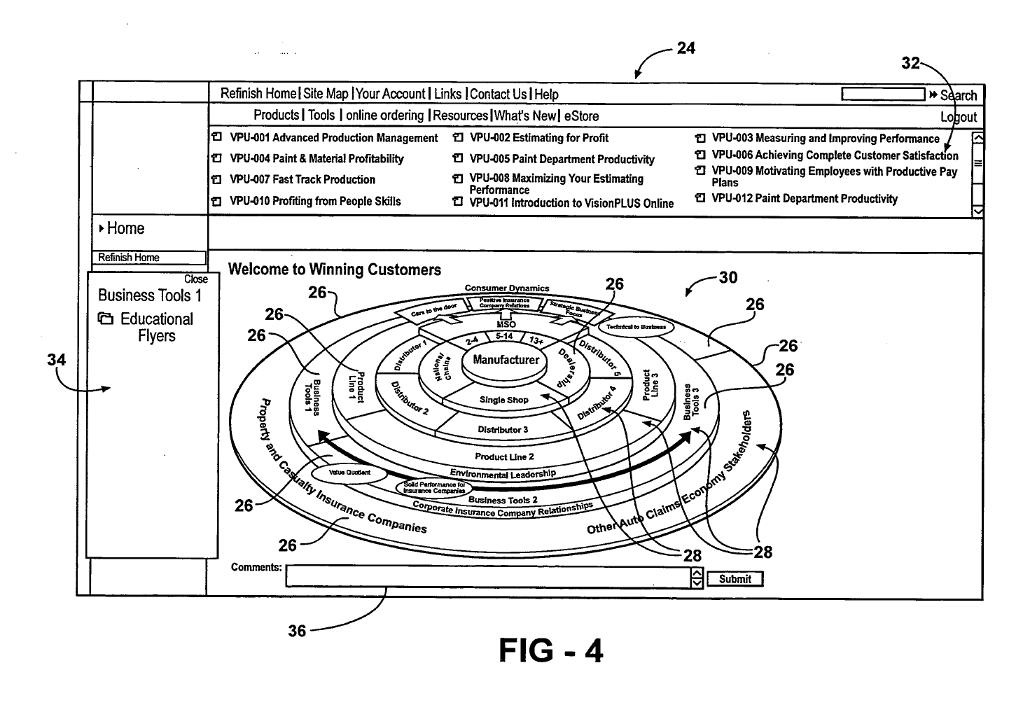

Each category 26 is selectable by the user, using the input device 20 as described above. The method 100 continues with the step 108 of receiving a selection from the user of one of the categories 26 displayed on the graphic 30 via the input device 20. In the illustrated embodiment, as shown in FIG. 4, the selected category appears to lift up to acknowledge the selection to the user.

In response to receiving the selection from the user, the method 100 continues with the step 110 of presenting a list 32 of marketing products to the user via the display 24. The list 32 of marketing products corresponds to the category 26 selected by the user. For ease of sorting the various marketing products corresponding to the category 26 selected by the user, the list 32 may be broken down into directories 34. The user selects one of the directories 34 and the list 32 of marketing products corresponding to the category 26 and the directory 34 are shown.

The user then selects one (or more) of the marketing products presented on the list 32. Accordingly, the method 100 continues with the step 112 of receiving a selection from the user via the input device 20 of one of the marketing products presented on the list 32.

In response to receiving the selection of the marketing product from the user, the method 100 continues with the step 114 of sending the marketing product selected by the user from the list 32. In the system 10 described above, this step 114 includes transmitting the marketing product over the telecommunications network 18 from the data storage device 12 to the terminal 16.

As described above, the marketing product may be of many forms, such as, but not limited to, documents and computer programs. Where the marketing product is a document, the method 100 includes the step of displaying the marketing product to the user on the display 24. Where the marketing product is a computer program, the method 100 includes the step of executing the computer program on the terminal 16.

The system 10 and method 100 described above provide an efficient technique for salespersons (and other stakeholders) to obtain marketing products. The system 10 and method 100, in essence, provide a “one-stop shop” for marketing information. This saves the salesperson significant time and energy in locating desired marketing products. Furthermore, by categorizing the marketing products, the salesperson is ensured that only the most proper and suitable marketing products are accessed by the user for each particular category of product.

Preferably, the user must log into the system 10 via the terminal 16 in order to gain access to the features set forth above. Specifically, the user enters a user name and a password via the keyboard or other input device 20. Thus, the system 10 can identify the user based on his or her account and configure the system 10 accordingly. Furthermore, the user may be required to agree to certain legal requirements, such as acceptable terms of use and/or a privacy policy before access to the system 10 is granted.

The graphic 30 may be presented in a modified or filtered form based on various criteria. One criterion is the type of user that is accessing the system 10. For instance, if the user is a particular type of distributor, the graphic 30 may be modified to show only one distributor category 26. Accordingly, that user will not have access to marketing products that are specifically tailored to other types of distributors.

Furthermore, certain content of the system 10 may also be restricted based on various criteria, such as the type of user. These restrictions may or may not be reflected in a modification or filtering of the graphic 30. For instance, a certain user may not see certain marketing products on the list 32 that are available to other users.

The display 24 may also show a feedback box 36, as depicted in FIGS. 3 and 4. The feedback box 36 allows the user of the system 10 to enter feedback, such as questions, comments, and/or concerns regarding the operation of the system 10. The text entered into the feedback box 36 is sent, via email or other suitable technique, to a system administrator. The system administrator can then address the user's concern and respond in a timely matter. This feedback box 36 allows a quick, convenient technique for relaying user feedback without use of a separate email or messaging program or navigation to another web page.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A computer-implemented method of providing marketing products to a user, said method comprising the steps of:
storing the marketing products in a data storage device;
categorizing the marketing products such that each marketing product is associated with at least one category;
displaying a graphic viewable by the user via a display wherein the graphic is divided into a plurality of categories and wherein each category is selectable by the user;
receiving a selection from the user of one of the categories displayed on the graphic via an input device;
presenting a list of marketing products to the user via the display in response to receiving the selection from the user wherein the list corresponds to the category selected by the user;
receiving a selection from the user via the input device of one of the marketing products presented on the list; and
sending the marketing product selected by the user from the list in response to receiving the selection of the marketing product from the user.

2. A method as set forth in claim 1 wherein said step of sending the marketing product includes the step of transmitting the marketing product over a telecommunications network from the file server to a terminal disposed remote from the file server.

3. A method as set forth in claim 2 wherein the marketing product is further defined as a document and said method further comprises the step of displaying the marketing product to the user in response to the document being transmitted from the file server to the terminal.

4. A method as set forth in claim 3 wherein the marketing product is further defined as a computer program and said method further comprises the step of executing the computer program on the terminal in response to the computer program being transmitted from the file server to the terminal.

5. A method as set forth in claim 1 further comprising the step of visually grouping a plurality of categories together based on a common characteristic to form a plurality of category groups.

6. A method as set forth in claim 5 wherein one of the category groups is further defined as a customer category group formed of a plurality of categories with each category relating to a different classification of customer.

7. A method as set forth in claim 6 wherein one of the category groups is further defined as a distributor category group formed of a plurality of categories with each category relating to a different classification of distributor.

8. A method as set forth in claim 7 wherein one of the category groups is further defined as a product category group formed of a plurality of categories with each category relating to a different classification of product.

9. A method as set forth in claim 8 wherein the product relates to paint for vehicle refinishing, the distributor relates to a distributor of the paint, and the customer relates to a consumer of the paint.

10. A method as set forth in claim 5 wherein one the categories is further defined as a manufacturer category relating to a manufacturer of paint for vehicle refinishing.

11. A method as set forth in claim 5 wherein one the category groups is further defined as an educational product category group formed of a plurality of categories with each category relating to a different classification of educational product.

12. A method as set forth in claim 5 wherein one of the category groups is further defined as an insurance claims category group formed of a plurality of categories with each category relating to a different aspect of insurance claims.

13. A method as set forth in claim 5 wherein each category group is represented in the graphic as a geometric shape with each geometric shape arranged around a common axis.

14. A method as set forth in claim 13 wherein at least one of the geometric shapes is circular.

15. A computer-implemented method of providing vehicle refinishing marketing products to a user, said method comprising the steps of:
storing a plurality of the marketing products in a computerized file server;
categorizing the marketing products such that each marketing product is associated with at least one category;
grouping a plurality of categories together based on a common characteristic to form a plurality of category groups.
displaying a graphic viewable by the user wherein the graphic is divided into a plurality of categories and wherein each category is selectable by the user and is graphically arranged according to its associated category group;
receiving a selection from the user from one of the categories of the graphic;
presenting a list of marketing products to the user via the display corresponding to the selected category in response to receiving the selection from the user;
receiving a selection from the user of one of the marketing products presented on the list; and
sending the marketing product selected by the user from the list in response to receiving the selection from the user.

16. A method as set forth in claim 15 wherein one of the category groups is further defined as a customer category group formed of a plurality of categories with each category relating to a different classification of customer, one of the category groups is further defined as a distributor category group formed of a plurality of categories with each category relating to a different classification of distributor, and one of the category groups is further defined as a product category group formed of a plurality of categories with each category relating to a different classification of product.

17. A system for providing vehicle refinishing marketing products to a user, said system comprising:
a data storage device for storing the marketing products in a categorized manner such that each marketing product is associated with at least one category;
a terminal in communication with said data storage device;
said terminal including a display for displaying a graphic viewable by the user wherein the graphic is divided into a plurality of categories and wherein each category is selectable by the user and for presenting a list of marketing products to the user in response to receiving a selection from the user wherein the list corresponds to the category selected by the user; and
said terminal further including an input device for receiving the selection from the user of one of the categories displayed on the graphic and for receiving a selection from the user of one of the marketing products presented on the list.

18. A system as set forth in claim 17 wherein said data storage device sends the marketing product selected by the user to said terminal in response to receiving the selection of the marketing product from the user.

19. A system as set forth in claim 18 wherein the marketing product is further defined as a document and said display also for displaying the marketing product to the user.

20. A system as set forth in claim 18 wherein the marketing product is a further defined as a computer program and said terminal includes a microprocessor for executing the computer program on said terminal.
